(19) United States
(12) Patent Application Publication
(10) Pub. No.: US 2026/0110347 A1
(43) Pub. Date: Apr. 23, 2026

(54) HYDRAULIC MOUNT

(71) Applicants: HYUNDAI MOTOR COMPANY, Seoul (KR); KIA CORPORATION, Seoul (KR)

(72) Inventor: Seung Ho Lee, Hwaseong-si (KR)

(73) Assignees: HYUNDAI MOTOR COMPANY, Seoul (KR); KIA CORPORATION, Seoul (KR)

(21) Appl. No.: 19/228,316

(22) Filed: Jun. 4, 2025

(30) Foreign Application Priority Data
Oct. 22, 2024 (KR) 10-2024-0144489

(51) Int. Cl. F16F 13/14; B60K 1/00; F16F 5/00

(52) U.S. Cl. CPC F16F 13/1463; B60K 1/00; F16F 5/00; F16F 2226/04; F16F 2226/045

(57) ABSTRACT

Disclosed is a hydraulic mount including an inner pipe, an outer pipe disposed on an outer side of the inner pipe, a main rubber formed between the inner pipe and the outer pipe, and a fluid chamber having fluid sealed therein, the fluid chamber being formed in the main rubber, wherein the fluid chamber includes an upper fluid chamber defined by the outer pipe and the main rubber, a lower fluid chamber defined by the outer pipe and the main rubber, and a rear fluid chamber formed on a rear side of the main rubber, the rear fluid chamber being configured to fluidly communicate with the upper fluid chamber and the lower fluid chamber.

### CROSS-REFERENCE TO RELATED APPLICATION

This application claims, under 35 U.S. C. § 119(a), the benefit of and priority to Korean Patent Application No. 10-2024-0144489, filed on Oct. 22, 2024, the entire contents of which are incorporated herein by reference.

### BACKGROUND

### (a) Technical Field

The present disclosure relates to a vehicle mount, and more specifically, to a hydraulic mount configured to mount a motor module of an electric vehicle thereon.

### (b) Background Art

Recently, research and development has been actively conducted on eco-friendly electric vehicles. An electric vehicle is driven by a motor instead of a conventional engine, and the motor receives power from a rechargeable battery.

A motor module including a motor and power electronics (PE) components is mounted in an electric vehicle using a mount. As compared with a vehicle including an internal combustion engine, an electric vehicle preferably uses a central support method so as to mount the motor module therein. Here, a motor mount is configured to be mounted on or press-fitted into a vehicle subframe to support the motor module. In addition, since the weight of an electric vehicle is smaller than that of a vehicle including a conventional engine, the motor module is usually mounted in the electric vehicle through a rubber bush type motor mount instead of a hydraulic motor mount.

Meanwhile, the weight of an electric vehicle increases due to batteries mounted in the electric vehicle, resulting in an increase in the tire size of the electric vehicle. Further, the electric vehicle has a problem related to residual vibration during traveling due to increased unsprung mass, which contributes to deterioration in ride comfort. Additionally, an electric vehicle has an aftershock problem to be solved.

The above information disclosed in this Background section is only for enhancement of understanding of the background of the disclosure, and therefore it may contain information that does not form the prior art that is already known to one having ordinary skill in the art.

### SUMMARY

The present disclosure has been made in an effort to solve the above-described problems associated with the prior art, and the present disclosure provides a hydraulic mount capable of eliminating residual vibration and aftershock during traveling of an electric vehicle.

The present disclosure also provides a hydraulic mount capable of improving ride and handling (R&H) performance and noise, vibration, and harshness (NVH) performance.

The objects of the present disclosure are not limited to the above-mentioned objects, and other technical objects not mentioned herein should be clearly understood by those having ordinary skill in the art to which the present disclosure pertains (hereinafter referred to as “one having ordinary skill in the art”) from the detailed description of the embodiments.

In one aspect of the present disclosure, a hydraulic mount includes an inner pipe, an outer pipe disposed on an outer side of the inner pipe, and a main rubber disposed between the inner pipe and the outer pipe. In particular, the main rubber is configured to define a fluid chamber in which fluid is sealed. The hydraulic mount further includes a nozzle assembly configured to surround the main rubber, and the nozzle assembly includes a first nozzle and a second nozzle. In an embodiment, the fluid chamber includes a first fluid chamber defined by the first nozzle and the main rubber, a second fluid chamber defined by the second nozzle and the main rubber, and a rear fluid chamber formed on a rear side of the main rubber. The rear fluid chamber is configured to fluidly communicate with the first fluid chamber and the second fluid chamber.

An embodiment of the present disclosure provides a vehicle comprising the hydraulic mount.

In another embodiment, a hydraulic mount comprises: an inner pipe; an outer pipe disposed on an outer surface of the inner pipe; a middle pipe disposed concentrically with the inner pipe and positioned between the inner pipe and the outer pipe; and a main rubber vulcanized between the middle pipe and the inner pipe. The main rubber is configured to define a fluid chamber in which fluid is sealed. In an embodiment, the fluid chamber comprises: a first fluid chamber defined by a first nozzle and the main rubber; a second fluid chamber defined by a second nozzle and the main rubber ; and a rear fluid chamber formed at an axial end of the main rubber. The rear fluid chamber is configured to fluidly communicate with the first fluid chamber and the second fluid chamber, and the first nozzle and the second nozzle are coupled to each other to surround the main rubber.

Other aspects and embodiments of the disclosure are discussed infra.

It is understood that the terms “vehicle,” “vehicular,” and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1 is a perspective view of a subframe of an electric vehicle, illustrating a state in which a hydraulic mount according to an embodiment of the present disclosure is mounted to the subframe;

FIG. 2 is a perspective view of the hydraulic mount according to an embodiment of the present disclosure;

FIG. 3 is an exploded perspective view of the hydraulic mount according to an embodiment of the present disclosure;

FIG. 4 is an axial cross-sectional view of the hydraulic mount according to an embodiment of the present disclosure;

FIG. 5A is an axial cross-sectional view of the hydraulic mount according to an embodiment of the present disclosure, illustrating a state in which an upward excitation force is applied to the hydraulic mount;

FIG. 5B is a perspective view of the hydraulic mount according to an embodiment of the present disclosure, illustrating fluid movement in the state illustrated in FIG. 5A;

FIG. 6A is an axial cross-sectional view of the hydraulic mount according to an embodiment of the present disclosure, illustrating a state in which a downward excitation force is applied to the hydraulic mount;

FIG. 6B is a perspective view of the hydraulic mount according to an embodiment of the present disclosure, illustrating fluid movement in the state illustrated in FIG. 5B;

FIG. 7 is a partial axial cross-sectional view of the hydraulic mount according to an embodiment of the present disclosure, illustrating a change in volume of a rear fluid chamber according to fluid movement in the states illustrated in FIGS. 5A and 6A; and

FIGS. 8A, 8B, 8C, and 8D are views each illustrating an assembly process of the hydraulic mount according to an embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes should be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. Specific structural or functional descriptions given in connection with the embodiments of the present disclosure are merely illustrative for the purpose of describing embodiments according to the concept of the present disclosure, and the embodiments according to the concept of the present disclosure may be implemented in various forms. Further, the present description is not intended to limit the present disclosure to the embodiments. On the contrary, the present disclosure is intended to cover not only the embodiments, but also various alternatives, modifications, equivalents, and other embodiments, which may be included within the spirit and scope of the present disclosure as defined by the appended claims.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to,” should be interpreted in the same manner. When a component, device, element, or the like of the present disclosure is described as having a purpose or performing an operation, function, or the like, the component, device, or element should be considered herein as being “configured to” meet that purpose or to perform that operation or function.

The same reference numerals represent the same components throughout the specification. Additionally, the terms in the specification are used merely to describe embodiments and are not intended to limit the present disclosure. In the present disclosure, an expression in a singular form also includes a plural form, unless clearly specified otherwise in context. As used herein, expressions such as “comprise” and/or “comprising” do not exclude the presence or addition of one or more components, steps, operations, and/or elements other than those described.

Hereinafter, the present disclosure is described in detail with reference to the accompanying drawings.

The present disclosure provides a hydraulic mount for a motor module capable of preventing deterioration in dynamic characteristics that may occur in the hydraulic mount. The hydraulic mount according to the present disclosure may substantially reduce or prevent residual vibration, aftershock, and deterioration in dynamic characteristics through at least three fluid chambers and a diaphragm.

An electric vehicle includes a motor configured to generate driving power and a power electronics (PE) module configured to supply power to the motor. Hereinafter, the motor and the PE module are collectively referred to as a motor module.

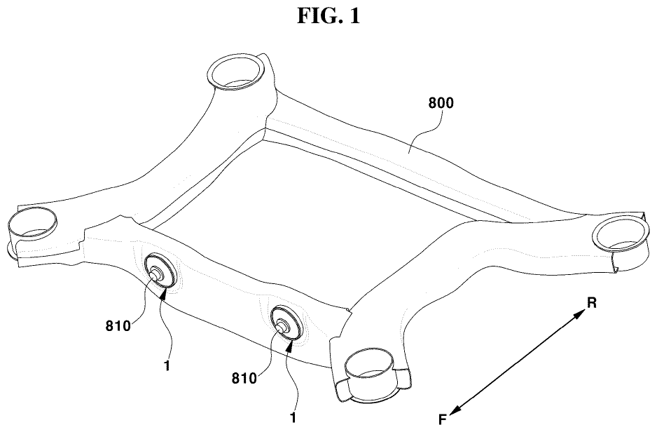

According to an embodiment of the present disclosure, referring to FIG. 1, a hydraulic mount 1 is configured to support a motor module and isolate vibration transmitted from the motor module to a vehicle body. The hydraulic mount 1 may be mounted on or press-fitted into a subframe 800 of a vehicle to support the motor module. The motor module may be located at the inside of the subframe 800. In an embodiment, the hydraulic mount 1 may be disposed in the forward-and-rearward (FR) direction of the vehicle. The hydraulic mount 1 may be coupled to the motor module via a bolt 810.

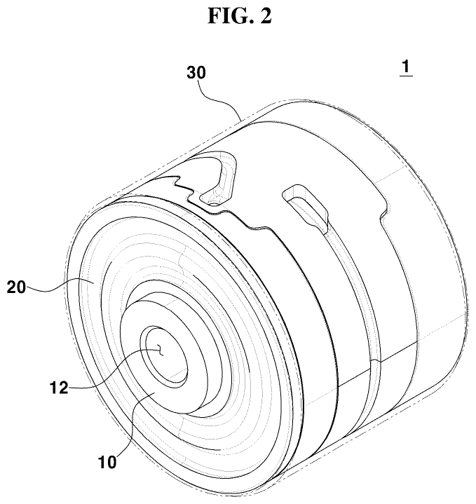

The hydraulic mount 1 is a mount including a rubber part in which fluid is sealed. As shown in FIG. 2, the hydraulic mount 1 may include an inner pipe 10, a main rubber 20, and an outer pipe 30.

The inner pipe 10 includes a hollow 12 formed therein. The hollow 12 may extend in the axial direction of the inner pipe 10. For example, the inner pipe 10 may have a tubular shape. The bolt 810 may be fastened into the hollow 12, and the motor module may be coupled to the hydraulic mount 1 through the bolt 810.

The main rubber 20 made of rubber may be disposed on the radially outer surface of the inner pipe 10. In one example, the main rubber 20 may be vulcanized around the radially outer surface of the inner pipe 10.

The outer pipe 30 may be disposed concentrically with the inner pipe 10. The outer pipe 30 may be disposed around the radially outer surface of the inner pipe 10, and the main rubber 20 may be disposed between the inner pipe 10 and the outer pipe 30.

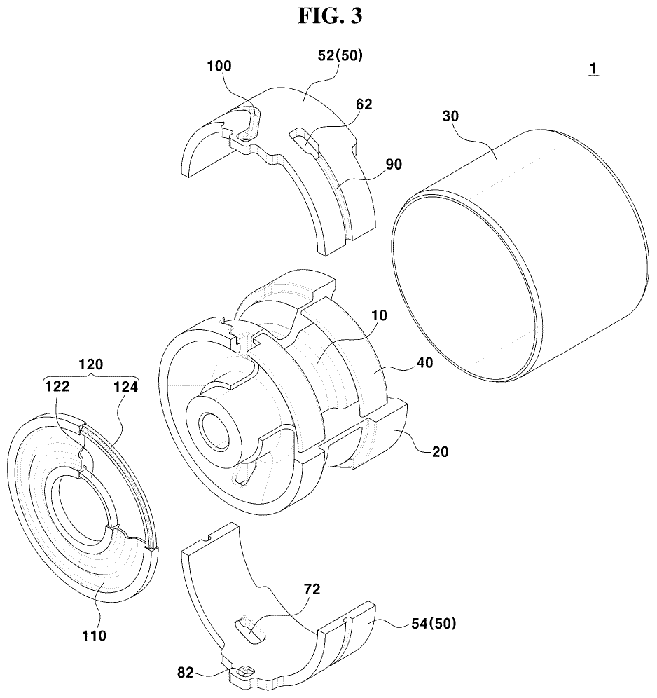

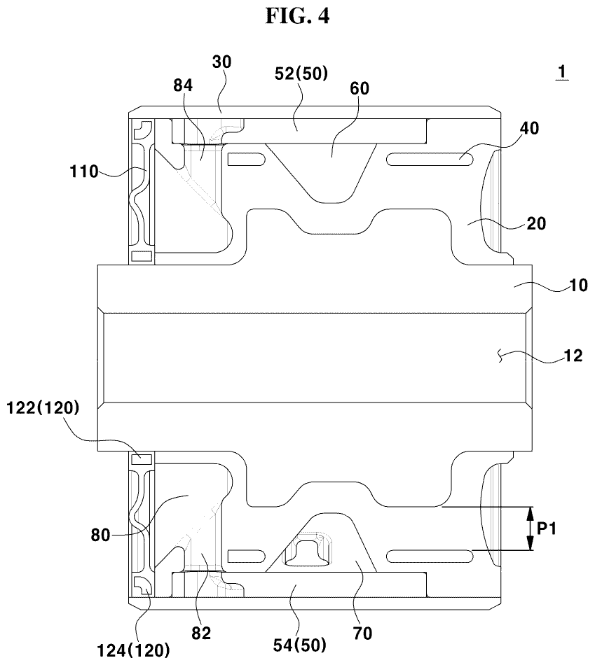

As shown in FIG. 3, according to an embodiment of the present disclosure, the hydraulic mount 1 may further include a middle pipe 40. The middle pipe 40 may be disposed concentrically with the inner pipe 10 and may be disposed between the inner pipe 10 and the outer pipe 30. The main rubber 20 may be vulcanized between the middle pipe 40 and the inner pipe 10, and the middle pipe 40 may be surrounded by the main rubber 20. In an embodiment, the main rubber 20 may include a bridge P1. The bridge P1 is configured to support a load in the main rubber 20. Referring to FIG. 4, the bridge P1 refers to a rubber portion extending from an upper or lower portion of the inner pipe 10 to the outer pipe 30 or a nozzle assembly 50. According to an embodiment of the present disclosure, a stopping structure of the inner pipe 10 and the middle pipe 40 may reduce the displacement of the main rubber. Accordingly, the main rubber 20 may be formed of a material having low hardness, thereby reducing high-frequency dynamic characteristics.

According to an embodiment of the present disclosure, the hydraulic mount 1 may further include the nozzle assembly 50. The nozzle assembly 50 may be disposed to surround the main rubber 20. In one example, the nozzle assembly 50 may include a first nozzle 52 (e.g., an upper nozzle 52) and a second nozzle 54 (e.g., a lower nozzle 54). The upper nozzle 52 and the lower nozzle 54 may be mounted on the main rubber 20 and may be coupled to each other to surround the main rubber 20.

Referring to FIG. 4, the nozzle assembly 50 forms a fluid chamber in which fluid is sealed. The fluid chamber is formed by the nozzle assembly 50 and the main rubber 20. The nozzle assembly 50 may further include a flow path through which the fluid in the fluid chamber flows. In an embodiment, a first fluid chamber 60 (e.g., an upper fluid chamber 60) is formed by the first nozzle (i.e., the upper nozzle 52) and the main rubber 20. The upper nozzle 52 has an opening 62 formed therein and configured to allow the fluid in the upper fluid chamber 60 to enter and exit therethrough. In an embodiment, a second fluid chamber 70 (e.g., a lower fluid chamber 70) may be formed by the second nozzle 54 (i.e., the lower nozzle 54) and the main rubber 20. The lower nozzle 54 has an opening 72 formed therein and configured to allow the fluid in the lower fluid chamber 70 to enter and exit therethrough.

In an embodiment, the fluid chamber further includes a rear fluid chamber 80. The rear fluid chamber 80 is configured to fluidly communicate with the upper fluid chamber 60 or the lower fluid chamber 70. More specifically, the rear fluid chamber 80 may fluidly communicate with the upper fluid chamber 60 and the lower fluid chamber 70 through flow paths 90 and 100.

The flow paths 90 and 100 may be formed on the surface of the nozzle assembly 50. The flow paths 90 and 100 may allow the fluid in the upper fluid chamber 60 or the lower fluid chamber 70 to flow into the rear fluid chamber 80 or allow the fluid in the rear fluid chamber 80 to flow into the upper fluid chamber 60 or the lower fluid chamber 70. To this end, in an embodiment, the flow paths 90 and 100 may include a first flow path 90 and a second flow path 100.

The rear fluid chamber 80 may be formed at the axial end of the main rubber 20. The rear fluid chamber 80 may be defined by the main rubber 20 and a diaphragm 110. The diaphragm 110 is mounted at the axial end of the main rubber 20. In an embodiment, the diaphragm 110 may be vulcanized into an annular frame 120. For example, the annular frame 120 may include an inner annular frame 122 and an outer annular frame 124 that are disposed concentrically. The diameter of the inner annular frame 122 may be configured to be smaller than the diameter of the outer annular frame 124. The inner annular frame 122 may be fitted to the inner pipe 10.

The first flow path 90 is configured to allow the opening 62 of the upper fluid chamber 60 and the rear fluid chamber 80 to communicate with each other. Specifically, the first flow path 90 may connect the opening 62 of the upper fluid chamber 60 to a lower inlet 82 of the rear fluid chamber 80. The first flow path 90 may be formed on the surface of the nozzle assembly 50 and may extend substantially in the circumferential direction of the nozzle assembly 50 from the opening 62 of the upper fluid chamber 60.

The second flow path 100 is configured to allow the opening 72 of the lower fluid chamber 70 and the rear fluid chamber 80 to communicate with each other. The second flow path 100 may connect the opening 72 of the lower fluid chamber 70 to an upper inlet 84 of the rear fluid chamber 80. The second flow path 100 may also be formed to be recessed from the surface of the nozzle assembly 50. The second flow path 100 may extend substantially from the opening 72 in the circumferential direction of the nozzle assembly 50.

In an embodiment, the first flow path 90 passes through the upper fluid chamber 60 and the rear fluid chamber 80, and the second flow path 100 passes through the lower fluid chamber 70 and the rear fluid chamber 80. However, the terms used herein are for clarity of explanation, and the first flow path may function as the second flow path, and the second flow path may function as the first flow path.

According to some embodiments of the present disclosure, the hydraulic mount 1 includes the upper fluid chamber 60, the lower fluid chamber 70, and the rear fluid chamber 80. The upper fluid chamber 60 and the lower fluid chamber 70 have volume stiffness. When a load is applied to the hydraulic mount 1, fluid may flow from the upper fluid chamber 60 or the lower fluid chamber 70 to the rear fluid chamber 80. The rear fluid chamber 80 is sealed by the diaphragm 110 such that the volume of the rear fluid chamber is easily changed when the fluid moves therein, thereby reducing the dynamic characteristics.

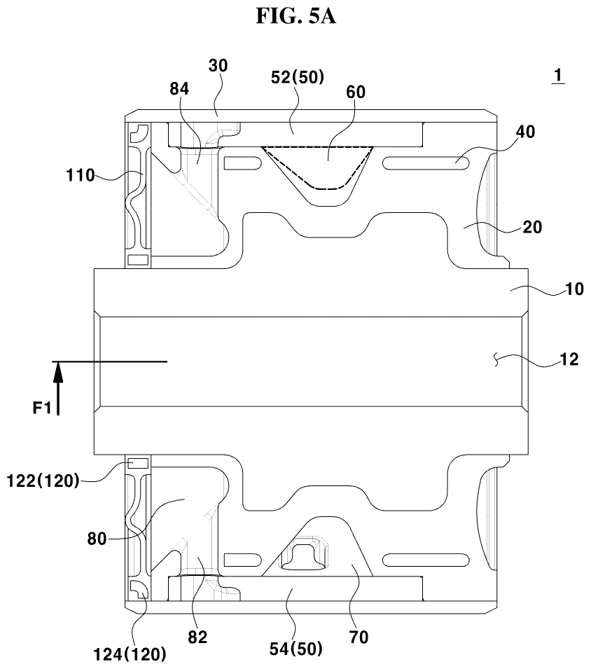

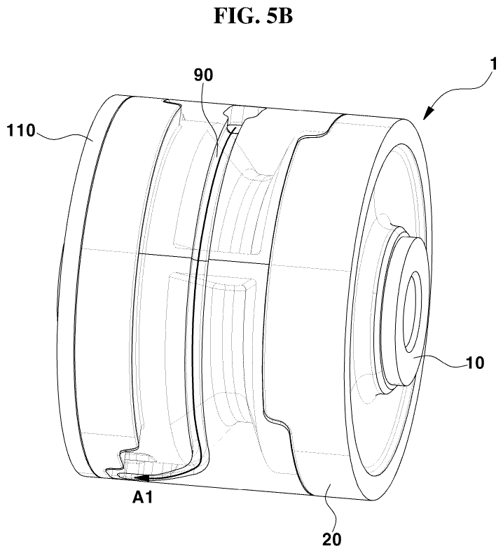

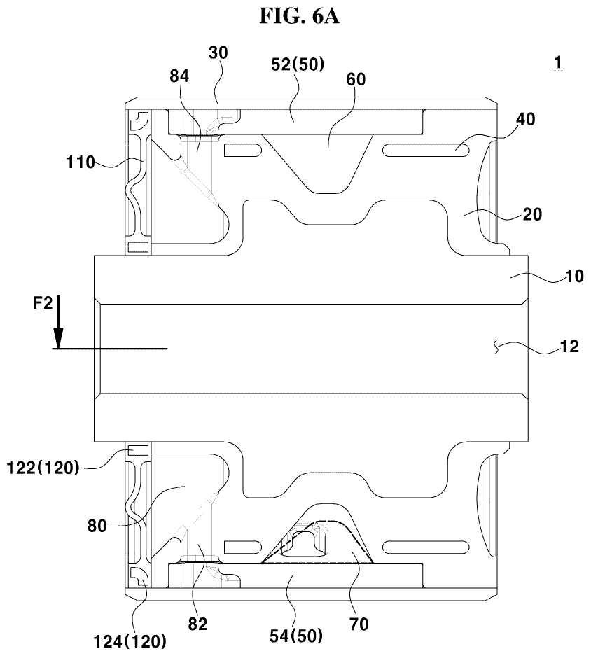

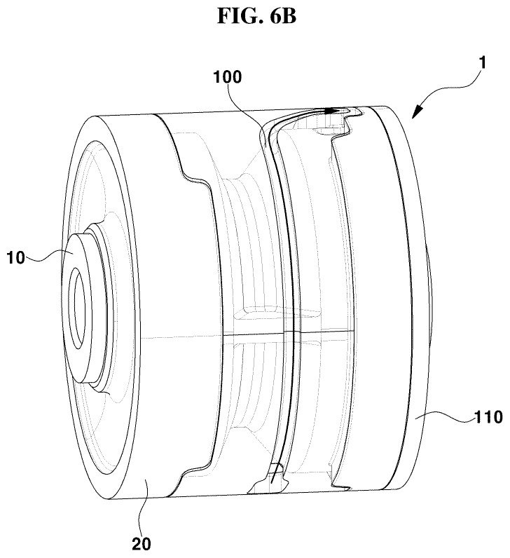

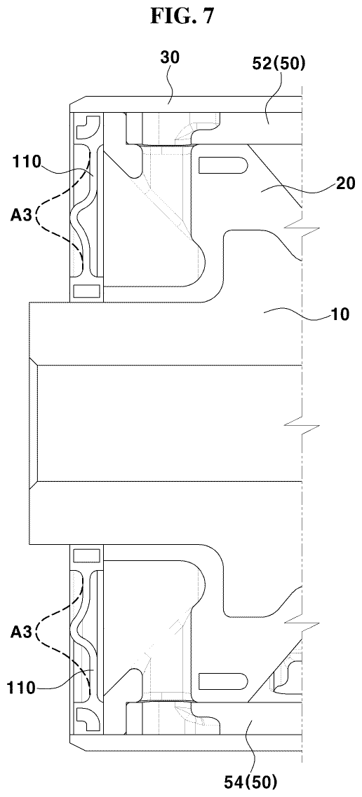

Referring to FIGS. 5A, 5B, 6A, and 6B, an operation flow when an external force is applied to the hydraulic mount 1 is described. As shown in FIGS. 5A and 5B, when an upward excitation force F1 is applied to the hydraulic mount 1, the volume of the upper fluid chamber 60 decreases as indicated by a dotted line. As a result, fluid in the upper fluid chamber 60 may be discharged from the upper fluid chamber 60. The fluid may flow along the first flow path 90 (in the direction A1) through the opening 62 of the upper fluid chamber 60 and may flow into the rear fluid chamber 80 through the lower inlet 82. As shown in FIGS. 6A and 6B, when a downward excitation force F2 is applied to the hydraulic mount 1, the volume of the lower fluid chamber 70 changes as indicated by a dotted line. As a result, fluid in the lower fluid chamber 70 may be discharged from the lower fluid chamber 70. The fluid may flow along the second flow path 100 (in the direction A2) through the opening 72 of the lower fluid chamber 70 and may flow into the rear fluid chamber 80 through the upper inlet 84. As shown in FIG. 7, when the fluid flows into the rear fluid chamber 80, the diaphragm 110 may expand outward, as indicated by a dotted line A3, in response to an increase in internal fluid pressure. In this manner, in the present disclosure, the volume of the hydraulic mount 1 may be easily changed by the diaphragm 110, thereby reducing the dynamic characteristics.

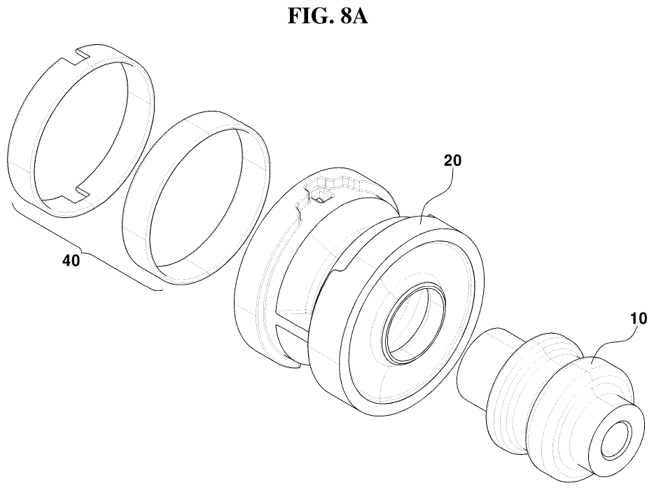

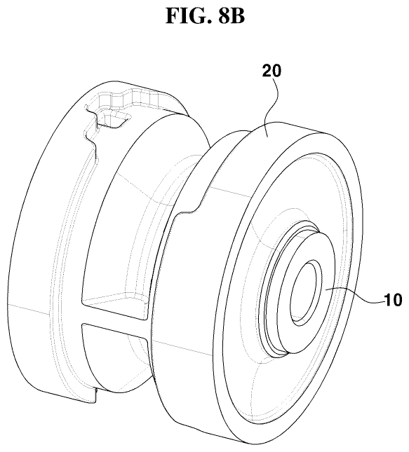

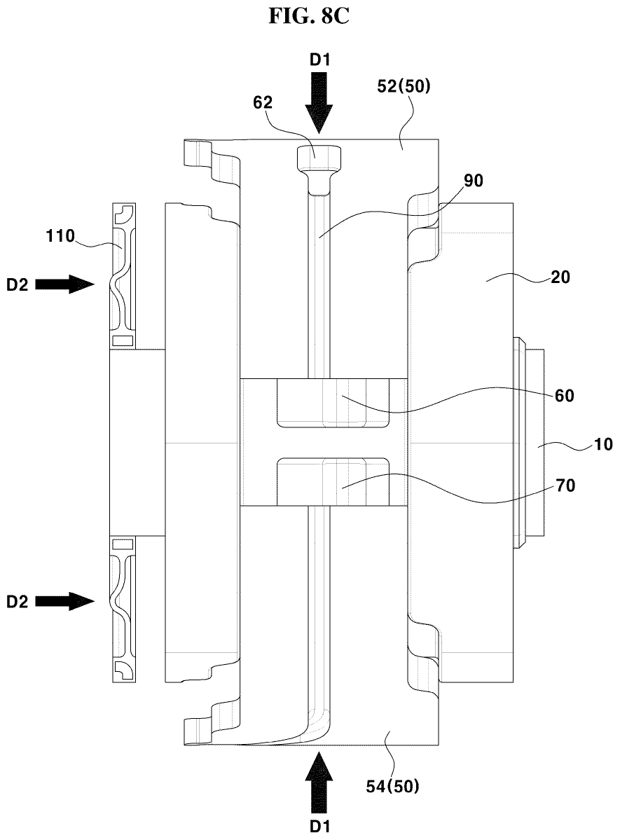

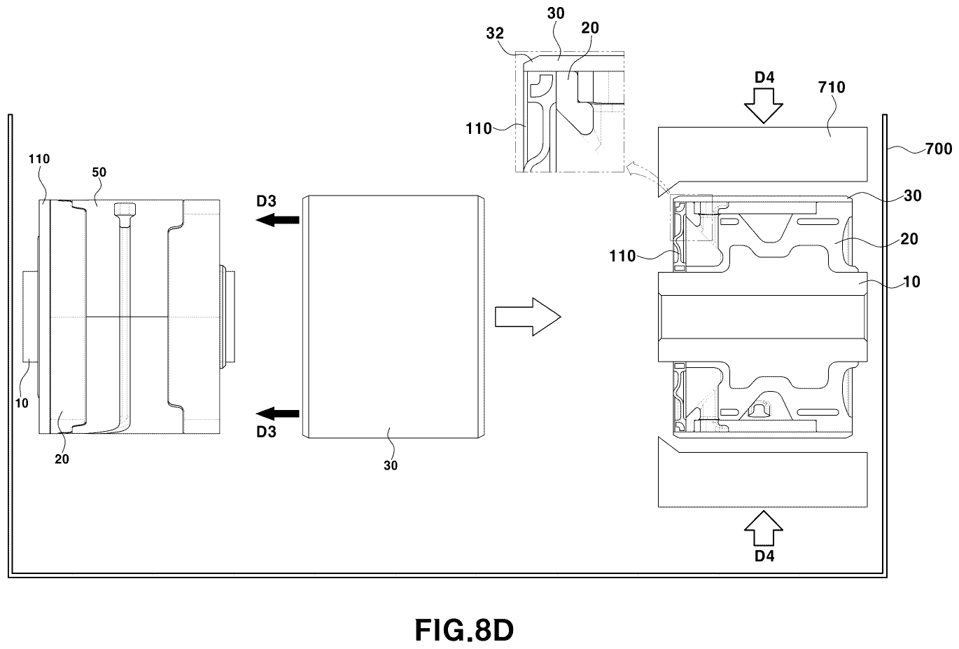

Referring to FIGS. 8A to 8D, an assembly process of the hydraulic mount 1 is described.

As shown in FIG. 8A, the middle pipe 40 is disposed concentrically with the inner pipe 10. The main rubber 20 is vulcanized between the inner pipe 10 and the middle pipe 40.

As shown in FIG. 8B, when the main rubber 20 is vulcanized, the middle pipe 40 is completely surrounded by the main rubber 20 and is not visible from the outside.

Referring to FIG. 8C, the nozzle assembly 50 is mounted around the circumference of the main rubber 20. The upper nozzle 52 and the lower nozzle 54 are each mounted on the main rubber 20 in the direction D1 and are connected to each other. When the upper nozzle 52 and the lower nozzle 54 are mounted on the main rubber 20, the first flow path 90 and the second flow path 100 may each extend along the circumference of the nozzle assembly 50. The diaphragm 110 vulcanized into the annular frame 120 is forcibly press-fitted into the inner pipe 10.

As shown in FIG. 8D, the assembly, swaging, and curling processes of the outer pipe 30 are performed in a tank 700 filled with hydraulic fluid. First, the outer pipe 30 is assembled with the assembly shown in FIG. 8C in the direction D3 in the hydraulic fluid. Then swaging of the hydraulic mount 1 is performed in the direction D4 using a jig 710 in the hydraulic fluid. Additionally, a curling process is performed to fix the diaphragm 110 press-fitted into the inner pipe. The end of the outer pipe 30 includes a curled portion 32. Sealing between the diaphragm 110 and the main rubber 20 may be secured through the curled portion 32.

In the conventional hydraulic mount for a motor module, the fluid chamber has been sealed with the main rubber. As a result, there is a problem in that dynamic characteristics are increased due to resistance to volume expansion during fluid movement. On the other hand, the present disclosure may solve the above-mentioned problem related to dynamic characteristics by providing the rear fluid chamber 80 including the diaphragm 110.

In addition, according to the present disclosure, during large displacement excitation in the vertical direction, when the upper part expands, the lower part contracts, the fluid may flow from the lower fluid chamber 70 to the rear fluid chamber 80, and the fluid in the rear fluid chamber 80 may flow into the upper fluid chamber 60 at the same time. In this manner, when the fluids in the respective chambers move simultaneously, a damping value is improved, thereby improving Ride and Handling (R&H) performance.

According to the present disclosure, the application of the rear fluid chamber 80 causes a main bridge to be inclined in the axial direction. This configuration facilitates tuning to increase axial stiffness.

In addition, according to the present disclosure, the displacement amount of the inner pipe 10 may be reduced by applying the stopping structure of the inner pipe 10 and the middle pipe 40. In this manner, it is possible to reduce high-frequency dynamic characteristics through the application of low hardness.

As is apparent from the above description, the present disclosure provides a hydraulic mount capable of substantially reducing or absorbing residual vibration and aftershock during traveling of an electric vehicle.

Further, the present disclosure provides a hydraulic mount capable of improving ride and handling (R&H) performance and noise, vibration, and harshness (NVH) performance.

The effects of the present disclosure are not limited to the above-mentioned effects, and other effects not mentioned herein should be clearly understood by those having ordinary skill in the art from the detailed description of the embodiments.

Although the present disclosure has been described in detail with reference to some embodiments thereof, the scope of the present disclosure is not limited to the above-described embodiments and the accompanying drawings, and it should be appreciated by those having ordinary skill in the art that various modifications and improvements may be made in the embodiments without departing from the principles and spirit of the disclosure, the scope of which is defined in the appended claims and equivalents thereto.

What is claimed is:

1. A hydraulic mount comprising:
an inner pipe;
an outer pipe disposed on an outer side of the inner pipe;
a main rubber disposed between the inner pipe and the outer pipe, the main rubber configured to define a fluid chamber in which fluid is sealed; and
a nozzle assembly configured to surround the main rubber and including a first nozzle and a second nozzle,
wherein the fluid chamber comprises:
a first fluid chamber defined by the first nozzle and the main rubber;
a second fluid chamber defined by the second nozzle and the main rubber; and
a rear fluid chamber formed on a rear side of the main rubber, the rear fluid chamber configured to fluidly communicate with the first fluid chamber and the second fluid chamber.

2. The hydraulic mount of claim 1, wherein when an upward excitation force is applied to the hydraulic mount, the fluid in the first fluid chamber is configured to flow into the rear fluid chamber.

3. The hydraulic mount of claim 2, wherein the fluid in the rear fluid chamber is configured to flow into the second fluid chamber.

4. The hydraulic mount of claim 1, wherein when a downward excitation force is applied to the hydraulic mount, the fluid in the second fluid chamber is configured to flow into the rear fluid chamber.

5. The hydraulic mount of claim 4, wherein the fluid in the rear fluid chamber is configured to flow into the first fluid chamber.

6. The hydraulic mount of claim 1, further comprising a diaphragm disposed at an axial end of the main rubber,
wherein the rear fluid chamber is defined by the main rubber and the diaphragm.

7. The hydraulic mount of claim 6, wherein the diaphragm is press-fitted into the inner pipe.

8. The hydraulic mount of claim 6, wherein the diaphragm is vulcanized into an annular frame.

9. The hydraulic mount of claim 6, wherein the outer pipe includes a curled portion formed at an end of the outer pipe, and the curled portion is configured to fix the diaphragm.

10. The hydraulic mount of claim 1, wherein the nozzle assembly is disposed between the main rubber and the outer pipe, and the nozzle assembly comprises a flow path for movement of the fluid.

11. The hydraulic mount of claim 10, wherein the flow path is recessed from a surface of the nozzle assembly.

12. The hydraulic mount of claim 10, wherein the flow path comprises a first flow path configured to allow the first fluid chamber and the rear fluid chamber to fluidly communicate with each other.

13. The hydraulic mount of claim 12, wherein the first flow path is configured to connect an upper opening configured to fluidly communicate with the first fluid chamber to a lower inlet of the rear fluid chamber.

14. The hydraulic mount of claim 10, wherein the flow path comprises a second flow path configured to allow the second fluid chamber and the rear fluid chamber to fluidly communicate with each other.

15. The hydraulic mount of claim 14, wherein the second flow path is configured to connect a lower opening configured to fluidly communicate with the second fluid chamber to an upper inlet of the rear fluid chamber.

16. A vehicle comprising a hydraulic mount, wherein the hydraulic mount comprises:
an inner pipe;
an outer pipe disposed on an outer side of the inner pipe;
a main rubber disposed between the inner pipe and the outer pipe, the main rubber configured to define a fluid chamber in which fluid is sealed; and
a nozzle assembly configured to surround the main rubber and including a first nozzle and a second nozzle,
wherein the fluid chamber comprises:
a first fluid chamber defined by the first nozzle and the main rubber;
a second fluid chamber defined by the second nozzle and the main rubber; and
a rear fluid chamber formed on a rear side of the main rubber, the rear fluid chamber configured to fluidly communicate with the first fluid chamber and the second fluid chamber.

17. The vehicle of claim 16, wherein the hydraulic mount is configured to mount a motor on the vehicle.

18. A hydraulic mount comprising:
an inner pipe;
an outer pipe disposed on an outer surface of the inner pipe;
a middle pipe disposed concentrically with the inner pipe and positioned between the inner pipe and the outer pipe; and
a main rubber vulcanized between the middle pipe and the inner pipe, the main rubber configured to define a fluid chamber in which fluid is sealed,
wherein the fluid chamber comprises:
a first fluid chamber defined by a first nozzle and the main rubber;
a second fluid chamber defined by a second nozzle and the main rubber; and
a rear fluid chamber formed at an axial end of the main rubber, and
wherein:
the rear fluid chamber is configured to fluidly communicate with the first fluid chamber and the second fluid chamber, and
the first nozzle and the second nozzle are coupled to each other to surround the main rubber.

19. The hydraulic mount of claim 18, further comprising a diaphragm mounted at the axial end of the main rubber, wherein the diaphragm and the main rubber are configured to define the rear fluid chamber.

20. The hydraulic mount of claim 19, wherein when an external force is applied to the hydraulic mount and the fluid flows into the rear fluid chamber, the diaphragm is configured to expand outward in response to an increase in internal fluid pressure.
